(19) United States
(12) Patent Application Publication
(10) Pub. No.: US 2020/0353296 A1
(43) Pub. Date: Nov. 12, 2020

(54) Designed Medical Mask

(71) Applicants: Melissa Crenshaw, Evensville, IN (US); James Crenshaw, Evensville, IN (US)

(72) Inventors: Melissa Crenshaw, Evensville, IN (US); James Crenshaw, Evensville, IN (US)

(21) Appl. No.: 16/865,987

(22) Filed: May 4, 2020

Related U.S. Application Data
(60) Provisional application No. 62/845,869, filed on May 10, 2019.

(51) Int. Cl. A62B 23/02; A62B 18/02; A41D 13/11; A41D 27/08

(52) U.S. Cl. CPC A62B 23/025; A41D 27/08; A41D 13/1161; A62B 18/025

(57) ABSTRACT

The present invention relates to a designer medical mask that allows a user to quickly and easily change the outer appearance or design of the medical mask with a plurality of interchangeable designs, patterns, images, text, logos, colors, etc., and without having to discard the underlying mask device. The improved medical mask also prevents or reduces the likelihood of the wearer experiencing wounds, pressure ulcers, skin damage or the like from wearing the mask for prolonged, uninterrupted periods of time. In addition to the interchangeable decorative covers, the medical mask is further comprised of a filter layer, a moisture wicking layer and a mask securing means that is more secure and easier to use than current medical mask designs, in addition to being more comfortable than both tied and loop medical mask designs.

### CROSS-REFERENCE TO RELATED APPLICATION

The present application claims priority to and the benefit of U.S. Provisional Application No. 62/845,869 filed on May 10, 2019, which is incorporated herein by reference in its entirety.

### BACKGROUND

The present invention relates generally to a new and improved filtered medical mask. More specifically, the invention relates to a designer medical mask that is comprised of a mask body having a front hooked surface and a corresponding loop-backed reusable/washable and readily interchangeable designer mask cover that can be removably attached to the mask body. The mask cover allows a user to change the appearance of the mask body quickly and readily via the hook and loop fastener connection with the mask body front surface. The mask body is additionally comprised of a non-woven, melt blown filter layer, and an interior layer comprised of a moisture wicking material for absorbing excess sweat and moisture away from the wearer's face and a padded rear surface. Additionally, the designer medical mask is secured to a wearer's face via a pair of padded straps, which are adjustable via a padded ladder lock buckle. Accordingly, the present specification makes specific reference thereto. However, it is to be appreciated that aspects of the present invention are also equally amenable to other like applications, devices and methods of manufacture.

Surgical and medical masks are designed to protect a user and those in close proximity to the user against contamination due to air-borne bacteria, pathogens, particulates, and the like by minimizing or eliminating the number of air-borne bacteria/pathogens which can be exhaled/inhaled by the user, and at the same time provide a relatively comfortable face covering which does not interfere with the actions and visibility of the user. Medical masks may also be employed by medical professionals to prevent contamination of a patient with the user's nasal/oral bacteria that may result from the user talking, sneezing, or coughing during, for example, a patient encounter or a medical procedure. Medical masks also protect the user's mouth and nose from contacting splashes or sprays of the patient's blood or other body fluids, and from other airborne bacteria and pathogens. Additionally, despite their name, the use of medical masks is not limited to medical uses and can also be used by non-medical personnel. For example, medical masks may be employed by private individuals in times of pandemics and other illness to help protect said individual from exposing others/becoming exposed to an airborne viral disease.

By way of background, existing surgical and/or medical masks are typically comprised of a mask body that covers the nose and mouth of the user, and two pairs of cloth or elastic ties that are each attached to each side of the mask body. These ties are typically wrapped around and tied behind the head of the user to secure the mask to the user's face, and said ties provide the mask with some adjustability as the user may position the ties to suit the user's comfort and/or preference. More specifically, one pair of ties is attached to the upper part of the mask body and is secured around the upper part of a user's head, and the other set of ties is attached to the lower part of the mask body, and is secured around the lower part of a user's head. Alternative embodiments of existing medical masks may be comprised of a pair of closed loop elastic ties which loop around the user's ears (as opposed to the user having to tie the two ends of the tie together behind the user's head, which may be cumbersome to new users), thereby securing the mask tightly to the head of the user with minimal effort.

However, both the tied medical mask design and the ear loop medical mask design suffer from certain deficiencies and present the opportunity for improper use of said masks. Further, this improper use typically results from the user's desire to increase his or her comfort while wearing the mask. For example, in the case of the medical mask having an ear loop design, the mask may become uncomfortable after long periods of time as the ear loops are continuously pulling on the back of the user's ears to secure the mask to the face/head of the user. This creates a pressure spot that could lead to skin irritation, increased perspiration, and tension headaches near the affected area. Over time, this discomfort can lead to an individual taking off their mask to alleviate the discomfort, thereby inadvertently allowing the possibility of exposure to pathogens/bacteria to occur.

Similarly, medical masks having a tied design could potentially impact a user in the same negative fashion, albeit in the back of the neck or head region, especially if a user ties one or both of the ties extremely tight. To attempt to alleviate this discomfort, as user may choose to secure only the upper part of the mask to the upper part of their head using one set of ties, while allowing the lower part of the mask and the corresponding ties to hang freely around the neck. Consequently, the bottom of the user's nose and mouth may be exposed to pathogens/bacteria at this time. In a similar manner, a user may alternatively secure the set of ties corresponding to the lower part of the mask and loosen the set of ties corresponding to the upper part of the mask, allowing the mask to hang at their neck, to increase their comfort (e.g. during a break in a medical procedure/surgery). This action would also lead to the possibility of the user being exposed to pathogens/bacteria. Additionally, since tied masks are physically tied by the user or another individual, said ties pose the risk of coming untied during their use, which further increases the likelihood of the mask inadequately protecting the face of the user from bacteria/pathogens, and could ultimately lead to the mask itself falling off of the face of the user.

Both mask designs also tend to create discomfort relating to the mask body coming into contact with the face of the user. For example, when wearing a medical mask for prolonged and uninterrupted periods of time, sweating underneath the mask may occur, as well as friction forces between the mask and the user's face, which can in turn lead to pressure damage on the nose and/or cheeks of the user. In addition, tears to the skin and ulcers can occur as a result of prolonged medical mask usage, which may result in an infection. Normally, dressing a wound would help minimize further damage and prevent infection. However, in the situation of a mask-caused wound, a dressing might prevent the mask from fitting correctly and, therefore, increase the risk of infection to the user from, for example, airborne pathogens.

Specific masks, such as the widely used and rigid N-95 respirator are known for their tight facial fit, with said fit being necessary to seal the mask around the mouth/nose and thereby rendering the mask effective at stopping airborne pathogens/bacteria. A team from the University of Huddersfield's institute of Skin Integrity and Infection Prevention detailed the underlying causes of pressure ulcers caused by the N-95 respirator, and provided suggestions for damage mitigation in a study published in the Journal of Wound Care. Specifically, the team noted that the N-95 mask creates a frictional force and pressure load, with said pressure load causing ulcers over a prolonged period of time on the face of the user. This is ultimately due to the fact that the pressure created by the mask is concentrated on a small area of skin due to the relatively small surface area of the mask's edge which comes into contact with the user's skin and bears a concentrated load. Stated differently, an N-95 respirator tightened onto the face of a user puts all pressure onto the soft tissue of the user's face that is in contact with the mask's edge. In addition, a user's skin condition and the mask's microclimate can further worsen damage caused as a result of pressure ulcers. While skin excessively moisturized by sweat and humidity trapped by the mask is susceptible to irritation, overly-dry skin can lead to greater inflammation by cracks and fissures. Further, masks may trap heat, thereby causing greater humidity within the mask and increasing skin fragility.

In addition to the potential for physical damage to occur to a user and the above referenced comfort issues related to existing surgical and medical masks, said masks also have an inherent on in terms of their ability to be personalized by the user. More specifically, most existing medical masks are produced in shades of white or blue, and lack any means to allow a user to personalize the appearance of the medical mask. While some forms of current medical masks are available in differing patterns/colors that contrast the typical white/blue shades, these masks are also limited in the regard that the user is limited to the specific design of each mask. In other words, if a user wishes to wear a mask with a different color, design, logo and/or pattern, the user must purchase a separate mask with said different color, design, logo and/or pattern, as no means currently exist to allow a user to quickly change the appearance/style of an existing mask. Additionally, many options a user may wish to display on their mask such as sports teams, logos, words, patterns, etc. are not commercially available today, and having to purchase many different masks can be both time consuming and expensive.

Therefore, there exists a long felt need in the art for an improved surgical or medical mask that prevents or reduces the likelihood of a user experiencing or suffering from wounds, pressure ulcers, skin damage or the like from wearing the mask for prolonged, uninterrupted periods of time. There also exists in the art a long felt need for an improved medical mask that is comprised of a securing means that is more secure and easier to use than current medical mask designs, in addition to being more comfortable than both tied and loop medical mask designs. Additionally, there is a long felt need in the art for a medical mask having a body portion that is comprised of both a filter layer and a moisture wicking layer. Finally, there exists a long felt need in the art for an improved medical mask that allows a user to quickly and easily change the outer appearance or design of the medical mask with a plurality of designs, patterns, images, text, logos, colors, etc. and without having to discard the underlying mask device.

The present invention in one exemplary embodiment discloses an improved medical mask that exhibits superior pathogen filtering and moisture wicking characteristics, and that can be easily personalized with a plurality of different and interchangeable mask covers to suit user need and/or preference. More specifically, the medical mask is comprised of an adjustable strap system and a body portion attached thereto. The adjustable strap system is preferably comprised of a plurality of padded straps that can be secured and adjustably tightened by the user using, for example, a ladder lock buckle. The body portion of the medical mask is preferably comprised of a plurality of layers including, without limitation, a user selectable and interchangeable decorative cover or first layer that is removably attached to a melt blown non-woven fabric filter layer that stops at least 95% of all pathogens/bacteria from passing therethrough, and a third layer that is placed immediately adjacent to the face of the user and is comprised of a moisture wicking fabric (e.g., a cotton, a polyester or other suitable material) to aid in perspiration prevention and ventilation. In a further preferred embodiment of the invention, the improved medical mask comprises a foam lined perimeter structure to help distribute the load of the mask on the user's face.

In this manner, the improved medical mask of the present invention accomplishes all of the forgoing objectives, thereby providing a user with a mask that prevents or decreases the likelihood of the user experiencing wounds, pressure ulcers, skin damage and the like from wearing the medical mask for prolonged periods of time due to its foam perimeter, moisture wicking backing, and adjustable padded straps. The improved medical mask of the present invention also provides a user with a securing means that is more secure, comfortable and easier to use than current tied mask or elastic loop designs. Finally, the user selectable and interchangeable decorative cover of the improved medical mask of the present invention allows the user to quickly and easily change and adorn the forward facing portion of the mask with user specified designs without the need to purchase a plurality of different masks, which can be both expensive and time consuming.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an improved surgical or medical mask. More specifically, the improved medical mask is preferably comprised of an adjustable strap system, a decorative mask body portion and a foam like perimeter member. The medical mask is secured to the face of the user via the adjustable strap system, which is comprised of a plurality of straps, with at least two straps being integrally connected to each side of the mask body. The straps are preferably comprised of a synthetic woven material, and the rear surface of each strap is comprised of a padded backing. Each strap assembly is further comprised of a 1st strap and a 2nd strap, with the 1st strap being integrally connected to a ladder lock buckle. To secure the decorative medical mask to his or her face, the user will loop the 2nd strap through the ladder lock buckle, and then pull the 2nd strap out of the ladder lock buckle until the medical mask reaches the desired tightness on the face of the user. In an alternative embodiment of the decorative medical mask of the present invention, the 2nd strap may also be comprised of a loop surface that adheres to a hook surface that comprises the top surface of the 2nd strap.

As previously stated, the decorative mask body portion is preferably comprised of a plurality of layers including, without limitation, a user selectable and interchangeable decorative cover or first layer, filter layer, and a third layer that is placed immediately adjacent to the face of the user. The decorative cover layer is a user selectable and interchangeable decorative cover that can contain any color, design, pattern, logo, message, etc. that suits user need and/or preference. The decorative cover may be removably attached to the intermediate filter layer by, for example, hook and loop fasteners, thereby enabling the user to quickly and easily change the cover of the medical mask without having to change the entire mask, which could be expensive and time consuming.

The intermediate filter layer is preferably comprised of a melt blown non-woven fabric that is capable of stopping at least 95% of all pathogens/bacteria, and is positioned or sandwiched between the decorative cover and the third layer. More specifically, the front or outward face of the filter layer (i.e., the face of the filter layer that faces away from the user when the improved medical mask is being worn) is preferably comprised of a plurality of hook or loop fasteners for engaging a corresponding set of hook and loop fasteners on the inboard or inner surface of the plurality of decorative covers.

The third layer of the body portion of the improved and decorative medical mask of the present invention is preferably comprised of a moisture wicking material that covers the entirety of the rear surface of the body portion, and helps prevent perspiration from forming/collecting on the area of the user's skin that is covered by the medical mask, whereby increased perspiration increases the chances of skin damage/ulcers forming, as noted supra. This third layer may be fixedly or removably attached to the filter layer, similar to the manner in which the filter layer is removably attached to the decorative cover layer.

As noted above, the improved medical mask may also comprise a foam lined perimeter structure to help distribute the load of the medical mask on the user's face. More specifically, the foam perimeter is preferably non-permeable to pathogens/bacteria, and widens the surface area of the mask perimeter, thereby increasing the surface area the pressure of the medical mask is distributed across and reducing the overall pressure on the user's skin which can lead to skin damage/ulcers. In differing embodiments of the present invention, the foam perimeter may also be comprised of a skin-safe adhesive backing that aids the medical mask in forming a better seal against the face area of the user.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a front perspective view of one possible embodiment of the medical mask of the present invention having an interchangeable decorative cover, and being utilized by a user in accordance with the disclosed architecture.

FIG. 2 illustrates a cross-sectional perspective view of one possible embodiment of the medical mask of the present invention having a plurality of layers and being worn by a user in accordance with the disclosed architecture.

FIG. 3 illustrates a side perspective view of one possible embodiment of the medical mask of the present invention being worn by a user in accordance with the disclosed architecture.

FIG. 4 illustrates a rear perspective view of the mask body of one possible embodiment of the medical mask of the present invention in accordance with the disclosed architecture.

FIG. 5 illustrates a perspective view of one possible embodiment of the ladder lock buckle of the adjustable strap assembly of the medical mask of the present invention in accordance with the disclosed architecture.

FIG. 6 illustrates a side perspective view of one possible embodiment of the adjustable strap assembly of the medical mask of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there exists a long felt need in the art for an improved medical mask that allows a user to quickly and easily change the outer appearance or design of the medical mask with a plurality of designs, patterns, images, text, logos, colors, etc., and without having to discard the underlying mask device. There is also a need for an improved surgical or medical mask design that prevents or reduces the likelihood of a user experiencing or suffering from wounds, pressure ulcers, skin damage or the like from wearing the mask for prolonged, uninterrupted periods of time, and for a medical mask body portion that is comprised of both a filter layer and a moisture wicking layer. Finally, there is a long felt need for an improved medical mask that is comprised of a securing means that is more secure and easier to use than current medical mask designs, in addition to being more comfortable than both tied and loop medical mask designs.

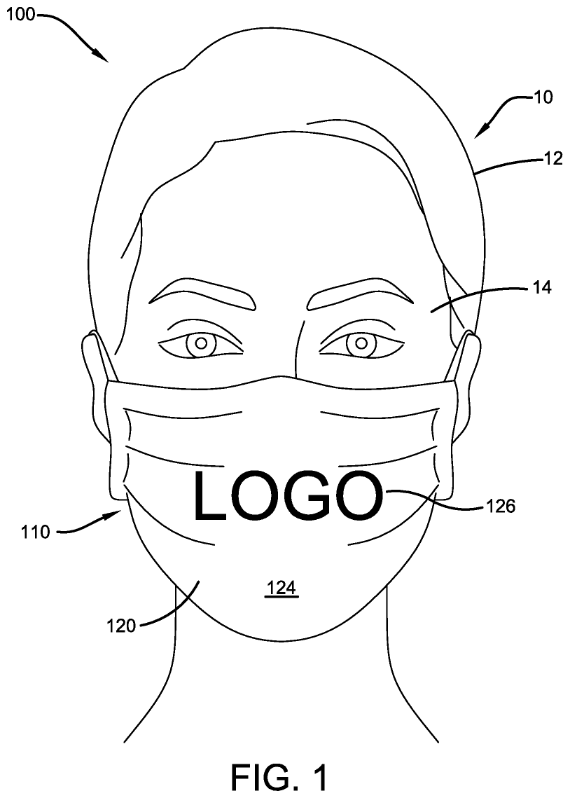

Referring initially to the drawings, FIG. 1 illustrates a front perspective view of one possible embodiment of the designer medical mask 100 of the present invention. Designer or decorative medical mask 100 is preferably comprised of a mask body portion 110, a foam structure 150 located on the interior or inboard perimeter of the mask body portion 110, and an adjustable strap assembly 170 adjustably attached to the mask body portion 110. Unless otherwise stated herein, each of the components of decorative medical mask 100 are comprised of sterile, medical grade materials.

Mask body portion 110 is preferably comprised of a plurality of fixedly or removably attached layers, namely a decorative cover 120, a filter layer 130, and a moisture wicking layer 140. Decorative cover 120 is generally rectangular in shape and comprised of a re-usable and washable cloth material comprised of cotton, polyester or other suitable material. Decorative cover 120 is further comprised of an inboard surface 122 and an outboard surface 124, wherein the term inboard as used herein refers to the surface facing the wearer 10, and the term outboard refers to the surface facing away from the wearer 10. The outboard surface 124 of the decorative layer 120 can display without limitation, any number of patterns, colors, logos 126, text, slogans, etc. desired by the wearer 10, thereby allowing the wearer 10 to easily customize the improved medical mask 100 of the present invention by simply changing the decorative cover 120.

More specifically, the inboard surface 122 of the decorative layer 120 is comprised of a plurality of fasteners 160, such as hook and loop fasteners, that correspond to a similar number of fasteners 160 positioned along an outboard surface of the filter layer 130, as explained more fully below. In addition to hook and loop fasteners, it is also contemplated that any other type of fastener can also be used such as buttons, snaps, zippers, etc. The hook and loop fasteners 160 of the decorative cover 120 and the filter layer 130 allow the wearer 10 the ability to quickly and readily attached/detach any number of different decorative mask covers 120 to the decorative mask device 100 to personalize the same without having to purchase multiple different medical masks, which could be both time consuming and expensive. For example, a wearer 10 may have several different decorative mask covers 120 that display the logos 126 of, for example, their favorite sports teams, player, show, artist, band, etc., and that can quickly be attached to the filter layer 130 via fasteners 160 to personalize the same.

Additionally, the re-usable/washable properties of the mask cover 120 material further allows a user 200 to wash/sterilize the cover 120 as necessary, whether that be in a medical or non-medical setting. In alternative embodiments of the present invention, the decorative mask cover 120 may completely cover the entirety of the outboard surface of the filter layer 130, matching all contours and dimensions, or it may only take up a portion of the outboard surface of the filter layer 130. It is further contemplated that decorative cover 120 could, in fact, be two different covers 120, each bearing a different logo 126 and each covering a portion of the outboard surface of the filter layer 130. In this manner, a wearer 10 may exhibit more than one, for example, sports team logo 126 at the same time.

Filter layer 130 is preferably a particulate/bacteria filter, and is comprised of a non-woven, melt blown filter material comprised of 100% polypropylene or other suitable material. The filter layer 130 acts as a fine particulate filter, thereby protecting the user 10 against at least 95% of any airborne dust, particulates, pathogens, or bacteria of 0.3+ microns-particles. In differing embodiments of the decorative medical mask 100, the filter layer 130 may be comprised of a coarse particulate filter that precedes the fine particulate filter and further protects the user 10 from larger/more coarse particulates.

Filter layer 130 is further comprised of an inboard surface 132 and an outboard surface 134, wherein the term inboard refers to the surface facing the wearer 10, and the term outboard refers to the surface facing away from the wearer 10. The outboard surface 144 of the decorative layer 130 is comprised of a plurality of fasteners 160, such as hook and loop fasteners, that correspond to a similar number of fasteners 160 positioned along the inboard surface of the decorative cover 120, as described above. As also previously stated, in addition to hook and loop fasteners, it is also contemplated that any other type of fastener can also be used such as buttons, snaps, zippers, etc. The hook and loop fasteners 160 of the filter layer 130 and the decorative cover 120 allow the wearer 10 the ability to quickly and readily attached/detach any number of different decorative mask covers 120 to the filter layer 130 to personalize the decorative medical mask as explained supra.

The third and inboard most layer of the decorative medical mask 100 is the moisture wicking layer 140, which is preferably comprised of a moisture wicking material such as polyester or polypropylene. Moisture wicking layer 140 is immediately adjacent to the face 14 of the wearer when medical mask 100 is being worn, and should therefore cover most if the wearer's face 14. More specifically, moisture wicking layer 140 is further comprised of an inboard surface 142 and an outboard surface 144, wherein the term inboard refers to the surface facing the wearer 10, and the term outboard refers to the surface facing away from the wearer 10 in the direction of filter layer 130. The moisture wicking material acts to move any perspiration away from the user's face area, thereby reducing the chance that a user 10 may develop skin damage/ulcers as a result of said perspiration, as mentioned supra, by the mask throughout the concentrated small area of skin due to the small surface area of the mask's edge. Therefore, the padding 124 should aid in mitigating the effects of such pressure, especially in rigid embodiments of the mask 100. However, it should be noted that the padding 124 is also applicable to non-rigid embodiments of the mask 100.

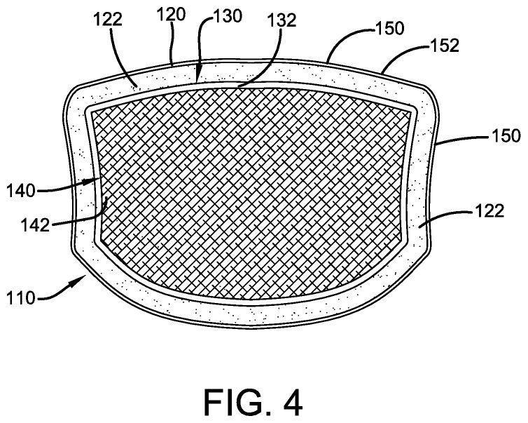

Moisture wicking layer 140 may be integrally formed with, fixedly attached to, or removably attached to the inboard surface 132 of filter layer 130. For example, wicking layer 140 may be sewn to the inboard surface 132 of filter layer 130, or it may be removably attached to the same by a plurality of fasteners 160 positioned along both the inboard surface 132 of filter layer 130 and a corresponding number of fasteners positioned along the outboard surface 144 of moisture wicking layer 140. In this manner, moisture wicking layer 140 may be removed from the filter layer 130 and properly cleaned or replaced without risking damage to the rest of decorative medical mask 100. FIG. 4 illustrates a rear perspective view of the mask body 110 of one embodiment of the present invention and clearly illustrates moisture wicking layer 140.

As previously stated, in a preferred embodiment of the present invention, the decorative medical mask 100 further comprises a foam structure 150 on the interior or inboard perimeter of the mask body portion 110. Foam structure 150 is fixedly attached to the inboard surface 142 of moisture wicking layer 140 and preferably extends along the entire length of the perimeter thereof to help distribute the load of the medical mask on the user's face. More specifically, the foam perimeter 150 is preferably non-permeable to pathogens/bacteria and widens the surface area of the mask body perimeter so that the pressure that the medical mask 100 exerts against the face 14 of the wearer 10 when worn is distributed across a wider area and reduces the overall pressure on the user's skin which can lead to skin damage/ulcers. In a further preferred embodiment of the present invention, the foam perimeter 150 may also be comprised of a skin-safe adhesive backing 152 that aids the medical mask body portion 110 in forming a better seal against the face 14 of the user 10.

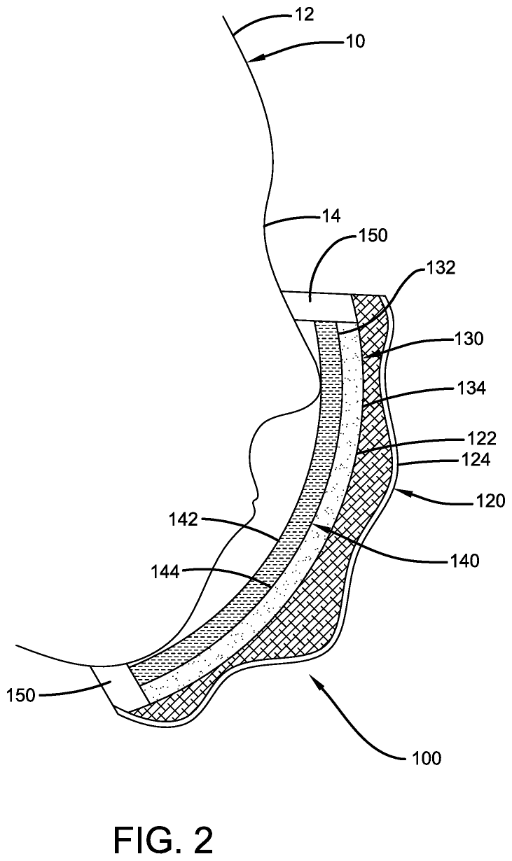

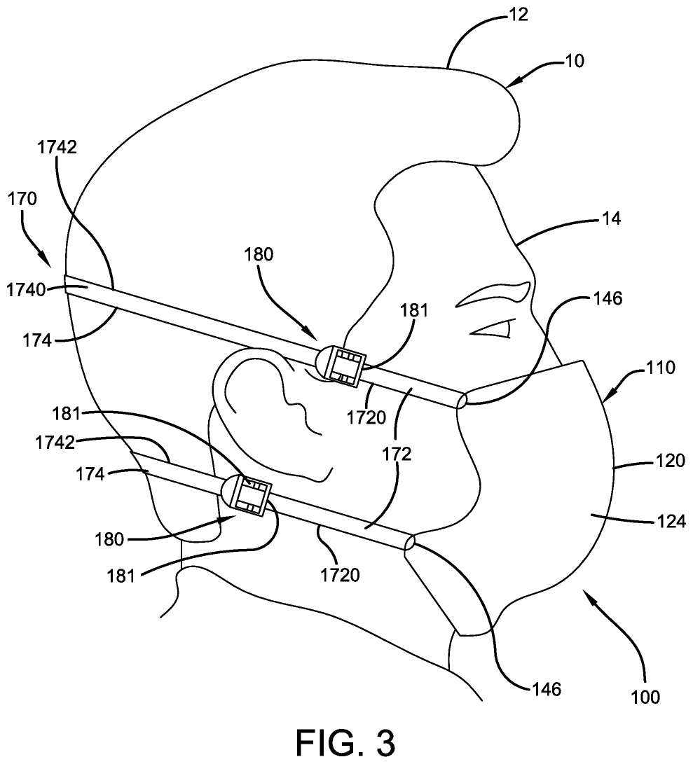

Additionally, and as best shown in FIGS. 2 and 3, one or more of filter layer 130 and/or moisture wicking layer 140 may further comprise an opening 146 formed therein for receipt of a portion of adjustable strap assembly 170. The adjustable strap assembly 170 is preferably comprised of a first strap 172 having a bottom surface 1720, a second strap 174 having a top surface 1740 and a bottom surface 1742, and a ladder lock buckle 180. The first strap 172 is preferably sewn or secured in a similar fashion to the opening 146 on each side of the mask body after it has been looped around the ladder lock buckle 180 and secured in place by a series of stiches or other fastening means so that it is affixed to the buckle 180 permanently. The second strap 174 is also secured through openings in the ladder lock buckle 180 as explained more fully below. A user 10 may adjust the tightness of all strap assemblies 170 via pulling the second strap 174 through or out of the ladder lock buckle 180. It is contemplated that a user 10 may also choose to leave all strap assemblies 170 in a loosened state, place the decorative mask 100 around the user's head 12, and then tighten all strap assemblies 170 via the method described to best ensure that optimal fit/tightness is achieved. Unlike existing tied masks, the strap assembly 170 of the present invention provides a user 10 with a means of securing the decorative medical mask 100 to the user's face 14 that does not nearly require the same amount of dexterity needed to tie a tied mask, which could be an issue for elderly users and/or users with disabilities. In addition, the strap assembly 170 of the present invention has a much lower probability of coming unfastening than a tied mask has of coming untied.

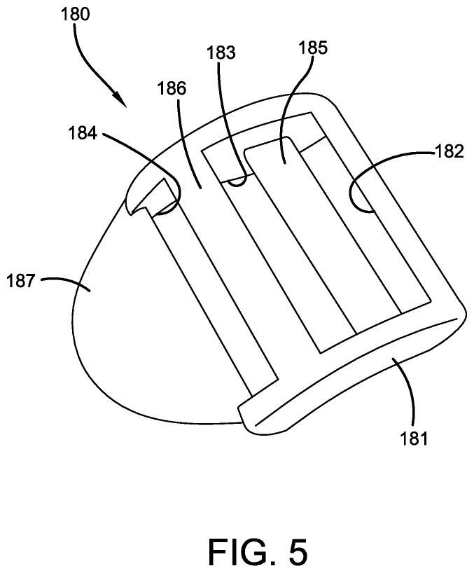

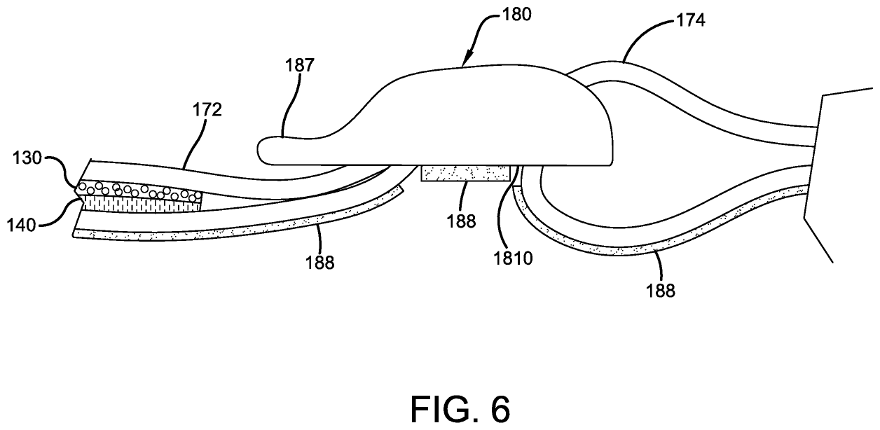

FIG. 5 illustrates a perspective view of one embodiment of ladder lock buckle 180, which is comprised of a frame 181 having a bottom surface 1810, a first continuous opening 182, a second continuous opening 183, a third continuous opening 184, a first support bar 185, a second support bar 186, and a pull tab 187. Nonetheless, it is also contemplated that ladder lock buckle 180 may be comprised of only a single opening and a single support arm. The first continuous opening 182 of the buckle 180 allows the first strap 172 of the strap assembly 170 to be looped around the frame 181 and secured via a stitched or other fastening means on the underside of the frame 181, which can best be observed in FIG. 6. The second strap 174 enters the buckle 180 from the bottom side of the second opening 183, and travels over top the second support bar 186 and out again through the bottom of the frame 181 via the third opening 184. Once both straps 172/174 are secured through the buckle 180, the strap assembly 170 can be tightened by the user 10 via the grasping of the buckle pull tab 187 and manipulating said buckle 158 along the strap assembly 170 or by pulling the second strap 174 in a direction away from the buckle 180. The inverse of the forgoing procedure can be done to loosen the strap assembly 170.

FIG. 6 illustrates a side perspective view of one potential embodiment of ladder lock buckle 180 and strap assembly 170 in which the orientation of the first strap 172 and the second strap 174 of the strap assembly 170 within the ladder lock buckle 180 becomes apparent. When successfully secured through the buckle 180, the first strap 172 loops through the buckle frame 181, entering from the top of the frame 181, proceeding through the continuous first opening 182, and exiting the frame 181 through the bottom 1580. Once the first strap 172 has exited the frame 181 it can then be secured to itself via a stitched or adhesive means. Similarly, the second strap 174 enters the frame 181 through the bottom 1810 of the frame 181, and then proceeds through the second continuous opening 183, around the second support bar 186, and back down through the third continuous opening 184, thereby exiting the frame 181 through the bottom 1810. Once the second strap 174 has exited the frame 181 it may then be secured via a hook and loop fasteners (not shown) so that it does not interfere with the user's face 14. Additionally, the bottom surfaces 1720/1742/1810 of the first strap 172, second strap 174, and ladder lock buckle 180 are preferably comprised of a foam structure or padding 188 similar to that of foam structure 150, with the exception of the adhesive backing 152. The foam padding 188 will again help ease the pressure of the strap assembly 170 and buckle 180 on the head 12 of the user 10, thereby reducing pressure spots and accompanying headaches that can be created by existing mask strap designs, as mentioned supra.

Notwithstanding the forgoing, the decorative medical mask 100 can be any suitable size, shape, and configuration as is known in the art without affecting the overall concept of the invention, provided that it accomplishes the above stated objectives. One of ordinary skill in the art will appreciate that the shape and size of the medical mask 100 and its various components, as shown in the FIGS. are for illustrative purposes only, and that many other shapes and sizes of the medical mask 100 are well within the scope of the present disclosure. Although dimensions of the medical mask 100 and its components (i.e., length, width, and height) are important design parameters for good performance, the medical mask 100 and may be any shape or size that ensures optimal performance during use and/or that suits user need and/or preference. This includes differing rigid and non-rigid embodiments of the medical mask 100 and their accompanying structures.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A medical mask comprising:
an adjustable strap assembly; and
a body portion, wherein the body portion is comprised of a decorative cover, a filter layer and a moisture wicking layer.

2. The medical mask of claim 1, wherein the adjustable strap assembly further comprises a first strap, a second strap, and a ladder lock buckle.

3. The medical mask of claim 1, wherein the filter layer is comprised of a non-woven melt blown polypropylene.

4. The medical mask of claim 1, wherein the decorative cover is removably attached to the filter layer via hook and loop fasteners.

5. The medical mask of claim 1, wherein the moisture wicking layer is removably attached to the filter layer via hook and loop fasteners.

6. The medical mask of claim 1, wherein a foam structure is positioned along a perimeter of the moisture wicking layer.

7. The medical mask of claim 6, wherein the foam structure is further comprised of a skin-safe adhesive backing.

8. The medical mask of claim 1, wherein the decorative cover is further comprised of at least one of: a color, a design, a pattern, a logo, and a message.

9. The medical mask of claim 1, wherein the moisture wicking layer is comprised of a cotton.

10. A medical mask comprising:
a strap assembly comprised of a first strap, a second strap and a buckle;
a body portion, wherein the body portion is comprised of a decorative cover, a filter layer and a moisture wicking layer; and
a foam structure.

11. The medical mask of claim 10, wherein each of the first strap, the second strap, and the ladder lock buckle are further comprised of a layer of padding.

12. The medical mask of claim 10, wherein the filter layer is comprised of a non-woven melt blown polypropylene.

13. The medical mask of claim 10, wherein the decorative cover is removably attached to the filter layer via hook and loop fasteners.

14. The medical mask of claim 10, wherein the moisture wicking layer is removably attached to the filter layer via hook and loop fasteners.

15. The medical mask of claim 10, wherein the foam structure is positioned along an entire length of a perimeter of the moisture wicking layer.

16. The medical mask of claim 10, wherein the foam structure is further comprised of a skin-safe adhesive backing.

17. The medical mask of claim 10, wherein the decorative cover is further comprised of at least one of: a color, a design, a pattern, a logo, and a message.

18. A medical mask comprising:
a strap assembly comprised of a first strap, a second strap and at least one buckle;
a body portion, wherein the body portion is comprised of a first decorative cover, a second decorative cover, a filter layer and a moisture wicking layer; and
a foam structure, wherein each of the first and second decorative covers are removably attached to the filter layer via a hook and loop fastener.

19. The medical mask of claim 18, wherein the filter layer is comprised of a non-woven melt blown polypropylene.

20. The medical mask of claim 18, wherein the moisture wicking layer is removably attached to the filter layer via hook and loop fasteners, and the foam structure is positioned along an entire length of a perimeter of the moisture wicking layer.
